(19) United States
(12) Patent Application Publication
(10) Pub. No.: US 2009/0273884 A1
(43) Pub. Date: Nov. 5, 2009

(54) CAPACITOR COMPONENT, METHOD OF MANUFACTURING THE SAME AND SEMICONDUCTOR PACKAGE

(75) Inventors: Noriyoshi Shimizu, Nagano-shi (JP); Osamu Inoue, Nagano-shi (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD., Nagano-shi (JP)

(21) Appl. No.: 12/431,937

(22) Filed: Apr. 29, 2009

(30) Foreign Application Priority Data
Apr. 30, 2008 (JP) P2008-118519

(51) Int. Cl. H01G 4/002; B44C 1/22

(52) U.S. Cl. 361/306.1; 216/6

(57) ABSTRACT

There are provided an upper electrode 18 and a lower electrode which are formed like flat plates, a dielectric layer interposed between the upper electrode and the lower electrode, and a covering portion which covers an external surface of at least one of the upper electrode and the lower electrode and is formed by an insulating resin. At least one of the upper electrode and the lower electrode is provided with at least one of opening holes having larger diameters than a via formed in a connection to a wiring pattern when a capacitor component is to be included in a substrate.

This application claims priority to Japanese Patent Application No. 2008-118519, filed Apr. 30, 2008, in the Japanese Patent Office. The Japanese Patent Application No. 2008-118519 is incorporated by reference in its entirety.

### TECHNICAL FIELD

The present disclosure relates to a capacitor component, a method of manufacturing the capacitor component and a semiconductor package, and more particularly to a capacitor component which can be included in a semiconductor package and can be thus used, a method of manufacturing the capacitor component and the semiconductor package using the capacitor component.

### RELATED ART

In order to improve a characteristic of a semiconductor package, a method of including a decoupling capacitor in a wiring substrate has been investigated. The wiring substrate including the decoupling capacitor has an advantage that a wiring distance from a semiconductor chip can be shortened to improve a characteristic of a semiconductor device more greatly, and furthermore, a size of an electronic component can be reduced more effectively as compared with a method of arranging a component such as a chip capacitor on a substrate.

A method of providing a decoupling capacitor on a wiring substrate includes a method of printing a dielectric film on a surface of a substrate to obtain a decoupling capacitor, a method of including, in a substrate, a decoupling capacitor having a dielectric film formed on a surface of an Si substrate, and a method of including, in a substrate, a ceramic chip capacitor or a solid electrolytic capacitor. Moreover, there is also a method of including a capacitor in a substrate by using a sheet material having a dielectric layer interposed between metal layers (Patent Document 1).

[Patent Document 1] JP-A-2006-310531 Publication

It has been demanded that a decoupling capacitor included in a substrate has an electric capacitance to some extent. Referring to a method of printing a dielectric film to obtain a decoupling capacitor, it is hard to increase a capacitance and it is difficult to obtain an electric capacitance of approximately 1 μF/cm².

In case of a method of forming a dielectric film on a surface of an Si substrate to obtain a capacitor, moreover, a dielectric is applied to the surface of the Si substrate and is then sintered at a high temperature. Therefore, it is necessary to provide a ground layer of the dielectric layer in such a manner that the dielectric is not diffused into Si in the sintering. There is a problem in that a manufacturing cost is increased due to a use of a heat-resistant metal such as Pt for the ground layer.

In case of a method of burying a chip capacitor in a substrate, moreover, there is a problem in that a total thickness of the substrate is increased due to a thickness of the chip capacitor. In the case in which a small-sized chip capacitor is used to reduce the thickness of the substrate, furthermore, there is a problem in that a large electric capacitance cannot be obtained.

### SUMMARY

Exemplary embodiments of the present invention provide a capacitor component which can reduce a total thickness of a substrate, and furthermore, can obtain a large electric capacitance and can be suitably used as a capacitor included in a wiring substrate also in the case in which a thickness can be reduced and the capacitor is included in the wiring substrate, a method of manufacturing the capacitor component, and a semiconductor package using the capacitor component.

A capacitor component according to the invention includes an upper electrode and a lower electrode which are formed like flat plates; a dielectric layer interposed between the upper electrode and the lower electrode; and a covering portion which covers an external surface of at least one of the upper electrode and the lower electrode and is formed by an insulating resin.

At least one of the upper electrode and the lower electrode includes at least one opening hole having a larger diameter than a via formed in a connection to a wiring pattern when the capacitor component is to be included in a substrate. By forming a connecting via hole in a position of the opening hole, consequently, it is possible to connect the via to the upper and lower electrodes from one of surface sides of the capacitor component.

Moreover, both the upper electrode and the lower electrode include opening holes having larger diameters than the via and opening holes having smaller diameters than the via, respectively, and the opening holes having the smaller diameters which are formed on the upper electrode and the lower electrode are provided to be positioned in a plane region of the opening holes having the larger diameters which are formed on the lower electrode and the upper electrode, respectively. By forming the via corresponding to a position of the opening hole having the smaller diameter, consequently, it is possible to form a via so as to penetrate the capacitor component, thereby connecting one of the vias and the other via to the upper and lower electrodes, respectively.

Furthermore, the invention provides a method of manufacturing a capacitor component using a capacitor sheet in which a dielectric layer is provided on a surface of a support layer formed of a metal and a metal layer is provided on the dielectric layer, comprising the steps of: etching the metal layer and the support layer into a predetermined pattern and forming them as an upper electrode and a lower electrode, respectively; covering, with an insulating resin, at least one of surfaces of the capacitor sheet on which the upper electrode and the lower electrode are formed; and cutting the capacitor sheet having a covering portion formed by the insulating resin into the capacitor component to be an individual piece.

In addition, the invention provides a semiconductor package includes a capacitor component buried in an insulating layer, the capacitor component including an upper electrode and a lower electrode which are formed like flat plates, a dielectric layer interposed between the upper electrode and the lower electrode, and a covering portion which covers an external surface of at least one of the upper electrode and the lower electrode and is formed by an insulating resin; a wiring pattern formed on the insulating layer; and vias through which the upper and lower electrodes and a wiring pattern are electrically connected to each other.

As the structure of the semiconductor package, moreover, the capacitor component includes opening holes having larger diameters than the via and opening holes having smaller diameters than the via on both the upper electrode and the lower electrode, and the opening holes having the smaller diameters which are formed on the upper electrode and the lower electrode are provided to be positioned in a plane region of the opening holes having the larger diameters which are formed on the lower electrode and the upper electrode, respectively, the vias are provided to penetrate the insulating layer and the capacitor component in a vertical direction in alignment with the opening holes having the smaller diameters which are formed on the upper electrode and the lower electrode, respectively, and one of the vias is electrically connected to the upper electrode and the other via is electrically connected to the lower electrode.

As the structure of the semiconductor package, furthermore, the capacitor component includes at least one opening hole having a larger diameter than the via on at least one of the upper electrode and the lower electrode, and one of the vias is connected to one of the upper electrode and the lower electrode and the other via is connected to the other in alignment with a position of the opening hole.

In addition, the invention provides a semiconductor package includes a core substrate with a capacitor structure, the capacitor structure including an upper electrode and a lower electrode which are formed like flat plates, a dielectric layer interposed between the upper electrode and the lower electrode, and a covering portion which covers external surfaces of the upper electrode and the lower electrode and is formed by an insulating resin; a wiring pattern formed on a surface of the core substrate; and vias through which the upper and lower electrodes are electrically connected to each other.

As another structure of the semiconductor package, moreover, he capacitor structure includes opening holes having larger diameters than the via and opening holes having smaller diameters than the via on both the upper electrode and the lower electrode, and the opening holes having the smaller diameters which are formed on the upper electrode and the lower electrode are provided to be positioned in a plane region of the opening holes having the larger diameters which are formed on the lower electrode and the upper electrode, respectively, and the vias are provided to penetrate the core substrate in a vertical direction in alignment with the opening holes having the smaller diameters which are formed on the upper electrode and the lower electrode, respectively, and one of the vias is electrically connected to the upper electrode and the other via is electrically connected to the lower electrode.

As a further structure of the semiconductor package, furthermore, the capacitor structure includes at least one opening hole having a larger diameter than the via on at least one of the upper electrode and the lower electrode, and one of the vias is connected to one of the upper electrode and the lower electrode and the other via is connected to the other in alignment with a position of the opening hole.

The capacitor component according to the invention has the structure in which the dielectric layer is interposed between the upper and lower layers and the external surface is covered by the covering portion. Consequently, it is possible to reduce a thickness and a size, and furthermore, to ensure a predetermined electric capacitance. Thus, the capacitor component can be suitably used to be included in the substrate. Moreover, the semiconductor package according to the invention is provided as a wiring substrate including the capacitor component to reduce the size of the substrate, and is provided as a product having the function for stabilizing a power supply. In the semiconductor package having the capacitor structure in the core substrate, furthermore, it is possible to further reduce the size and the thickness as a substrate having a decoupling capacitor.

Other features and advantages may be apparent from the following detailed description, the accompanying drawings and the claims.

### BRIEF DESCRIPTION OF THE DRAWINGS

FIGS. 1A to 1F are sectional views showing a process for manufacturing a capacitor component,

FIG. 2A is a sectional view showing the process for manufacturing the capacitor component, and FIGS. 2B and 2C are sectional and plan views showing the capacitor component, respectively,

FIGS. 3A and 3B are plan views showing upper and lower electrodes which constitute the capacitor component, respectively,

FIGS. 4A and 4B are sectional views showing other examples of the structure of the capacitor component,

FIG. 5A is a sectional view showing a further structure of the capacitor component, and FIGS. 5B and 5C are plan views showing the upper and lower electrodes, respectively,

FIGS. 6A to 6D are sectional views showing a process for manufacturing a wiring substrate mounting the capacitor component thereon,

FIGS. 7A to 7D are sectional views showing the process for manufacturing the wiring substrate mounting the capacitor component thereon,

FIG. 8 is a sectional view showing a state in which a via hole is formed corresponding to an opening hole provided on the capacitor component,

FIG. 9 is a sectional view showing a state in which the capacitor component is mounted on a substrate,

FIGS. 10A to 10G are sectional views showing a method of manufacturing a wiring substrate including a capacitor in a core substrate,

FIG. 11 is a side view showing a semiconductor package assembled by using the wiring substrate including the capacitor, and

FIG. 12 is a sectional view showing the wiring substrate having the capacitor provided in the core substrate.

### DETAILED DESCRIPTION

### (Capacitor Component)

First of all, description will be given to a method of manufacturing a capacitor component according to the invention.

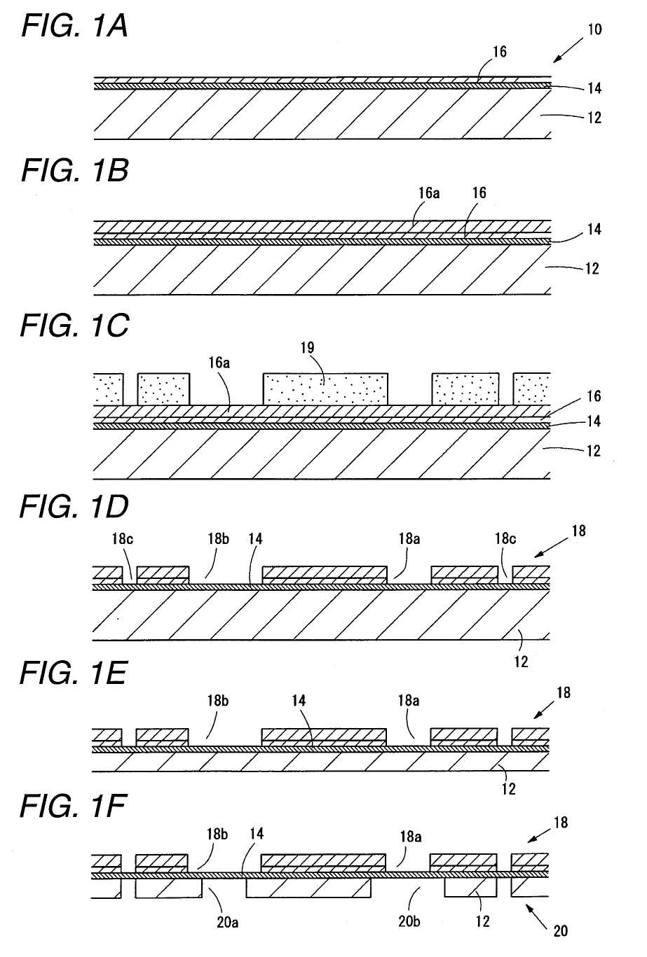

FIG. 1A shows a capacitor sheet 10 to be used for manufacturing the capacitor component. The capacitor sheet 10 is formed to have a structure in which a nickel layer 12 to be a support layer of the capacitor sheet 10, a dielectric layer 14 and a copper foil 16 are stacked.

The capacitor sheet 10 is a product which is previously formed to take a shape of a large plate and a capacitor component according to the invention is manufactured by utilizing the capacitor sheet 10.

The dielectric layer 14 is formed on a surface of the nickel layer 12 to be the support layer through sintering. The nickel layer 12 is formed to have such a thickness that the capacitor sheet 10 can retain a shape, and at the same time, also functions as a support for sintering a dielectric and forming the dielectric layer 14. A sintering temperature of the dielectric is high. However, nickel has a sufficient heat resistance in a nitrogen atmosphere. By sintering the dielectric by setting the nickel layer 12 as the support, it is possible to form the dielectric layer 14 on the surface of the nickel layer 12.

In the embodiment, BST (Barium Strontium Titanate) having a thickness of 500 nm is used as the dielectric layer 14. In addition, it is possible to use, as the dielectric layer 14, a material having a high dielectric constant such as barium titanate, strontium titanate, PZT (Lead Zirconate Titanate), PLZT (Lead Lanthanum Zirconate Titanate) or bismuth titanate.

Moreover, the nickel layer 12 having a thickness of 35 μm is used. The copper foil 16 is formed on the dielectric layer 14 by vapor deposition or sputtering.

FIG. 1B shows a state in which a copper plated layer 16a is thickly provided on a surface of the copper foil 16 by electrolytic copper plating using the copper foil 16 as a plated feeding layer in order to form an upper electrode of the capacitor component. The copper foil 16 has a thickness of approximately 2 μm and the copper plated layer 16a is formed in a thickness of approximately 18 μm by the copper plating.

In the case in which the copper foil (the metal layer) is formed in a predetermined thickness on a surface of the capacitor sheet 10, it is not necessary to thickly form the metal layer through the copper plating.

FIGS. 1C and 1D show a process for patterning the copper plated layer 16a and the copper foil 16 to form an upper electrode 18 of the capacitor component.

FIG. 1C shows a state in which a resist pattern 19 is formed in accordance with a plane pattern of the upper electrode 18. A dry film resist is provided on a surface of the copper plated layer 16a and the resist pattern 19 is formed by an exposure and a development. Subsequently, etching is carried out over the copper plated layer 16a and the copper foil 16 by using the resist pattern 19 as a mask to form opening holes 18a and 18b having bottom faces to which the dielectric layer 14 is exposed.

FIG. 1D shows a state in which the opening holes 18a and 18b are formed and the resist pattern 19 is then removed. Since the copper plated layer 16a and the copper foil 16 are formed by the same copper material, they are simultaneously etched by a copper etchant and are thus patterned. At the etching step, the nickel layer 12 is covered with a dry film and is thus protected from the etchant if necessary.

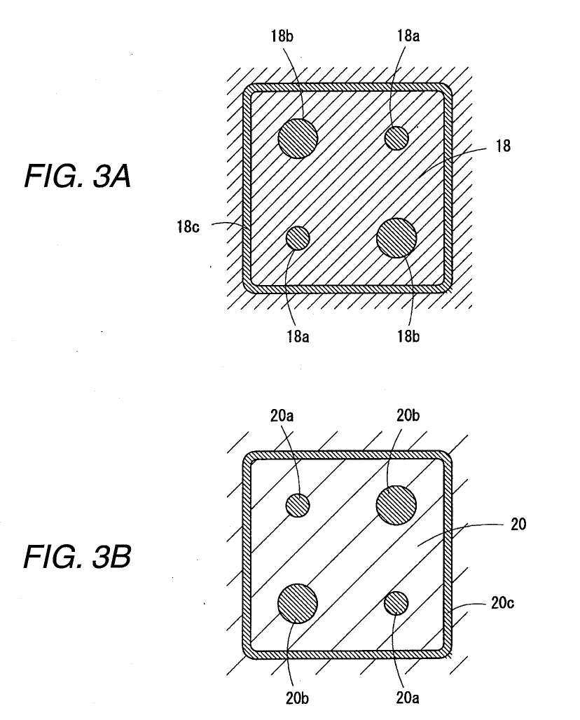

FIG. 3A shows an example of a plane pattern of the upper electrode 18 to be formed on the capacitor component. In the example, two opening holes 18a having a small diameter and taking a planar shape of a circle and two opening holes 18b having a large diameter and taking a planar shape of a circle are provided in a crossing arrangement, respectively. The opening hole 18a having the small diameter serves to electrically connect an upper electrode and a wiring pattern between layers through a via when the capacitor component is to be included in a substrate. The opening hole 18b having the large diameter serves to connect the wiring pattern to a lower electrode of the capacitor component and is formed to have such a diameter that a via can pass with room so as not to interfere with the upper electrode 18 when the wiring pattern and the lower electrode are to be connected to each other through the via. The diameter of the opening hole 18a having the small diameter is for example from 40 to 60 μm, and the diameter of the opening hole 18b having the large diameter for example from 60 to 80 μm. The arrangement of the opening holes 18a and 18b to be provided on the upper electrode 18 and the number of the arrangements can be set optionally.

An external shape of the upper electrode 18 is defined by a slit trench 18c provided along an outline position of the upper electrode 18. Although the upper electrode 18 in FIG. 3A takes a planar shape of a square, the planar shape of the upper electrode can be set optionally. In the capacitor component, the lower electrode is also formed to take a planar shape adapted to the upper electrode. A plane area of the dielectric layer 14 interposed between the upper electrode and the lower electrode is related to an electric capacitance. By taking plane areas of the upper and lower electrodes to be large, it is possible to increase the electric capacitance of the capacitor component.

FIGS. 1E and 1F show a process for patterning the nickel layer 12 to form a lower electrode 20 of the capacitor component.

FIG. 1E shows a state in which the nickel layer 12 is etched. In the embodiment, the nickel layer 12 having a thickness of 35 μm is thinned to have a thickness of 20 μm through the etching. When the etching is to be carried out over the nickel layer 12, the upper electrode 18 is covered with a dry film resist and is thus protected if necessary. The nickel layer 12 is subjected to the etching in order to reduce the thickness of the capacitor component as greatly as possible.

FIG. 1F shows a state in which the etched nickel layer 12 is subjected to patterning to form the lower electrode 20. In the same manner as in the case in which the upper electrode 18 is formed, the lower electrode 20 is also formed by providing a dry film resist on the surface of the nickel layer 12 and forming a resist pattern through an exposure and a development, and then etching the nickel layer 12 using the resist pattern as a mask. By using an etchant for selectively etching the nickel layer 12, it is possible to carry out the etching without damaging the upper electrode 18 formed of copper.

FIG. 3B shows an example of a plane pattern of the lower electrode 20. The plane pattern of the lower electrode 20 is used to make a pair with the upper electrode 18 shown in FIG. 3A. An opening hole 20b having a large diameter in the lower electrode 20 is placed in the position of the opening hole 18a having the small diameter which is formed on the upper electrode 18 and an opening hole 20a having a small diameter in the lower electrode 20 is placed in the position of the opening hole 18b having the large diameter in the upper electrode 18 in such a manner that respective planar shapes are circular, and they are provided in a concentric arrangement. The diameter of the opening hole 20a having the small diameter is for example from 40 to 60 μm, and the diameter of the opening hole 20b having the large diameter for example from 60 to 80 μm. An outline position of the lower electrode 20 is defined by a slit trench 20c. The planar shapes of the upper electrode 18 and the lower electrode 20 are identical to each other.

The opening holes to be provided on the upper electrode 18 and the lower electrode 20 do not need to be circular.

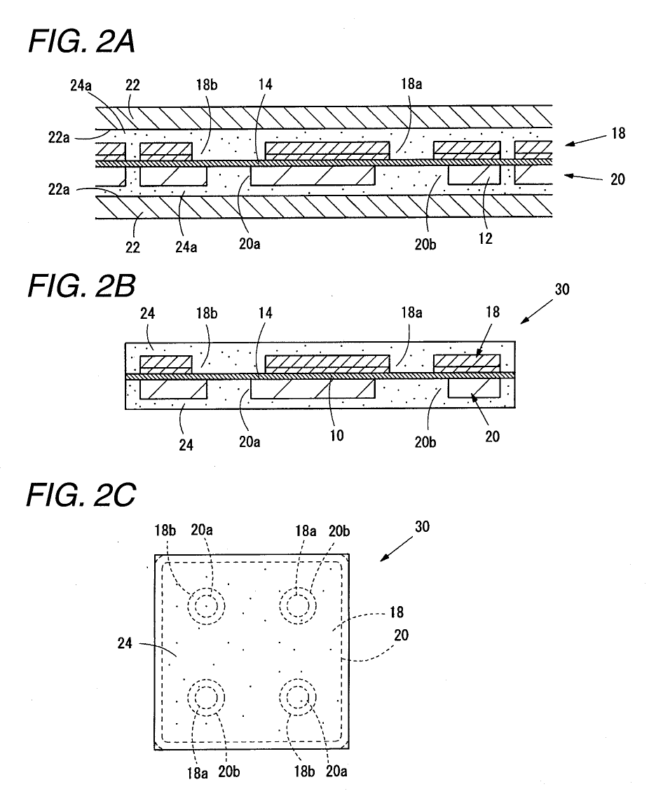

As described above, the capacitor sheet 10 is provided as a large sheet body. FIGS. 1A to 1F show a region of the capacitor component which is a unit to be formed in the capacitor sheet 10. When patterning the nickel layer 12, the copper foil 16 and the copper plated layer 16a in the capacitor sheet 10 to form the upper electrode 18 and the lower electrode 20, the upper electrode 18 and the lower electrode 20 are formed in an identical pattern to the pattern shown in FIGS. 1A to 2B in all of the unit regions in the capacitor sheet 10. As a matter of course, it is also possible to form the upper electrode 18 and the lower electrode 20 in another pattern for each unit region. The reason is that the resist pattern for patterning the nickel layer 12, the copper foil 16 and the copper plated layer 16a can be formed optionally.

There is carried out a process for forming the upper electrode 18 and the lower electrode 20 on both sides of the capacitor sheet 10 and then covering the both sides of the capacitor sheet 10 with an insulating resin.

FIG. 2A shows a state in which a copper plate 22 is heated and pressurized onto the both sides of the capacitor sheet 10 having the upper electrode 18 and the lower electrode 20 formed therein in a state in which a surface having a resin 24a bonded thereto is turned toward the capacitor sheet 10. The resin 24a is bonded onto the both sides of the capacitor sheet 10 by pressure so that the upper electrode 18 and the lower electrode 20 are buried in the resin 24a and are thus sealed together with the dielectric layer 14.

The copper plate 22 having the resin 24a bonded to a single side is used for the following reason. More specifically, it is necessary to reliably seal the capacitor sheet through the resin 24a, thereby forming a resin flatly and to roughen an external surface of a covering portion 24 formed by the resin 24a covering the external surface of the capacitor sheet.

By heating and pressing the copper plate 22 to thermally cure the resin 24a and then removing the copper plate 22 through chemical etching, it is possible to obtain a sheet body in which the both sides of the capacitor sheet are sealed with the covering portion 24.

If the surface of the copper plate 22 to which the resin 24a is bonded is previously formed as a rough surface, it is possible to form the external surface of the covering portion 24 to be a rough surface by thermally curing the resin 24a and then removing the copper plate 22 through etching. By forming the external surface of the covering portion 24 to be the rough surface, it is possible to bond a resin material constituting the substrate to the capacitor component well by an anchor action when providing the capacitor component in the substrate.

Subsequently, it is possible to obtain a capacitor component 30 to be an individual piece by cutting a sheet body sealed with a resin for each unit region. FIG. 2B is a sectional view showing the capacitor component 30 and FIG. 2C is a plan view.

As shown in FIGS. 2B and 2C, the capacitor component 30 has an external surface covered with the covering portion 24 formed of a resin and includes the upper electrode 18 and the lower electrode 20 in an arrangement in which the dielectric layer 14 is interposed therebetween. The opening hole 18a having a small diameter and the opening hole 18b having a large diameter are formed on the upper electrode 18, and the opening hole 20a having a small diameter and the opening hole 20b having a large diameter are formed on the lower electrode 20 in a reverse arrangement to the upper electrode 18. The external surface of the covering portion 24 is formed to be a rough surface.

The capacitor component 30 according to the embodiment is obtained as a product having a predetermined shape retaining property in which the dielectric layer 14 is interposed between the upper electrode 18 and the lower electrode 20, and both sides are covered with the resin 24 so that the dielectric layer 14, the upper electrode 18 and the lower electrode 20 are protected through the resin 24. The electric capacitance of the capacitor is determined depending on a dielectric constant and a thickness of the dielectric layer 14 and plane areas of the upper electrode 18 and the lower electrode 20. By setting the plane areas of the dielectric layer 14, the upper electrode 18 and the lower electrode 20 to be larger, it is possible to increase the electric capacitance. According to the capacitor component in accordance with the embodiment, it is possible to obtain an electric capacitance of approximately 1 μF/cm².

Moreover, the capacitor component 30 according to the embodiment is suitably used for substrate integration because a total thickness containing a thickness of the resin 24 is approximately 80 to 100 μm and the capacitor component 30 is formed in a small thickness.

### (Another Example of Capacitor Component)

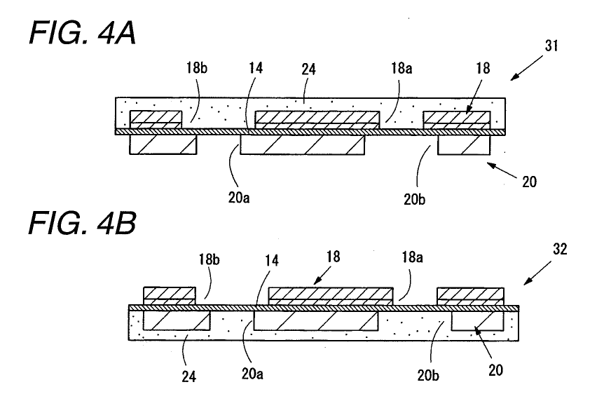

Although FIG. 2A shows the example in which the both sides of the capacitor sheet are sealed and formed with the resin 24a, it is also possible to obtain a capacitor component by sealing only one of the sides of the capacitor sheet with the resin 24a as shown in FIGS. 4A and 4B. FIG. 4A shows a capacitor component 31 in which the surface of the capacitor sheet on which the upper electrode 18 is provided is covered with the covering portion 24 formed by a resin, and FIG. 4B shows a capacitor component 32 in which the surface of the capacitor sheet on which the lower electrode 20 is provided is sealed with the resin. With the structure in which the single side of the capacitor sheet is sealed and covered with the covering portion 24, thus, there is an advantage that the thickness of the capacitor component can be reduced more greatly as compared with the case in which the both sides are covered with the covering portion 24.

In a comparison between the case in which the single side of the capacitor sheet is sealed with the covering portion 24 and the case in which the both sides are sealed with the covering portion 24, the case in which the both sides of the capacitor sheet are covered with the covering portion 24 is more advantageous in that a deformation such as a warpage of the capacitor component can be suppressed. In the case in which the single side of the capacitor sheet is sealed with the resin, it is possible to suppress a deformation such as a warpage by reducing the thickness of the resin and increasing the thickness of the electrode to some extent.

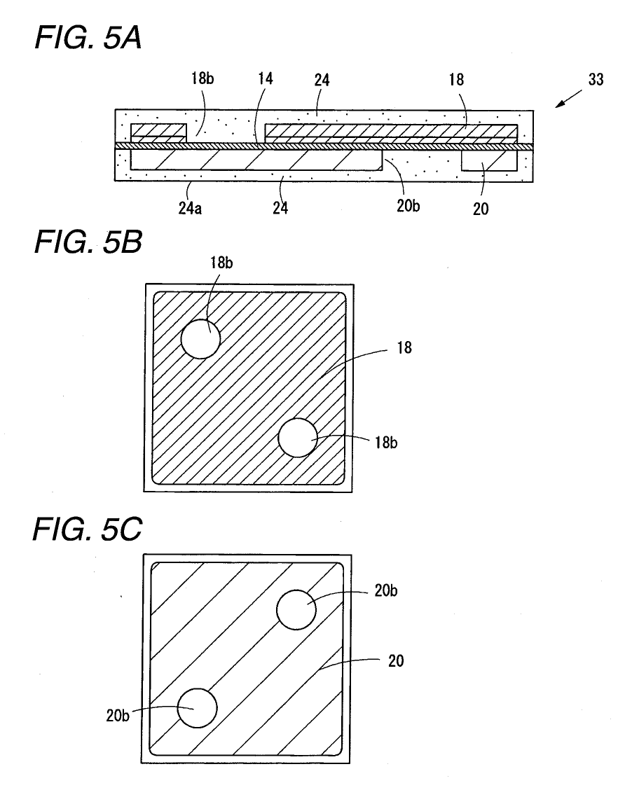

FIGS. 5A to 5C show another example of the structure of the upper electrode 18 and the lower electrode 20 which form the capacitor component. FIG. 5A is a sectional view, FIG. 5B is a plan view showing the upper electrode 18, and FIG. 5C is a plan view showing the lower electrode 20. A capacitor component 33 is characterized in that opening holes 18b and 20b having larger diameters than a via diameter are provided on both the upper electrode 18 and the lower electrode 20 and planar arranging positions of the opening holes 18b and 20b are placed without overlapping. Although two opening holes 18b and two opening holes 20b are provided on the upper electrode 18 and the lower electrode 20 in a diagonal arrangement in the example shown in the drawings, it is possible to properly select positions in which the opening holes 18b and 20b are arranged and the number of the arrangements.

### Semiconductor Package: First Embodiment

It is possible to provide wiring substrates (semiconductor packages) of an internal capacitor type by providing the capacitor components 30 to 33 in a substrate such as a printed substrate.

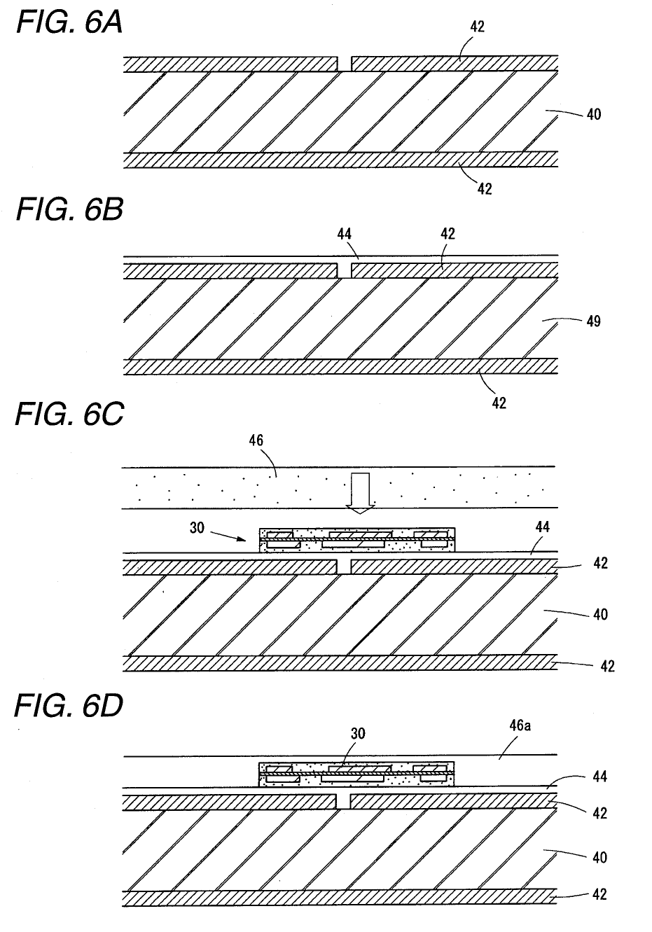

FIGS. 6 A to 7D show a manufacturing process for providing the capacitor component 30 shown in FIG. 2B in a substrate to form a wiring substrate.

FIG. 6A shows a state in which a copper foil 42 provided on an upper surface of a core substrate 40 formed by a double-sided copper-clad resin substrate is patterned into a predetermined pattern. At a step of patterning the copper foil 42, a predetermined wiring pattern is formed on both sides of the core substrate 40. In the drawing, there is shown a state in which a wiring pattern 42a is formed on the assumption that the capacitor component 30 is mounted on the upper surface of the core substrate 40.

FIG. 6B shows a state in which a resin film is provided on a surface of the core substrate 40 to form an insulating layer 44.

FIGS. 6C and 6D show a process for arranging the capacitor component 30 on the upper surface of the core substrate 40. The capacitor component 30 is disposed on the insulating layer 44 and a resin film 46 for buildup is provided from above the core substrate 40 so that the capacitor component 30 is disposed to be buried in the insulating layers 44 and 46a (FIG. 6D). There is an advantage that an adhesion of the insulating layers 44 and 46a and the capacitor component 30 can be enhanced by an anchor effect if the external surface of the covering portion 24 of the capacitor component 30 is formed to be a rough surface.

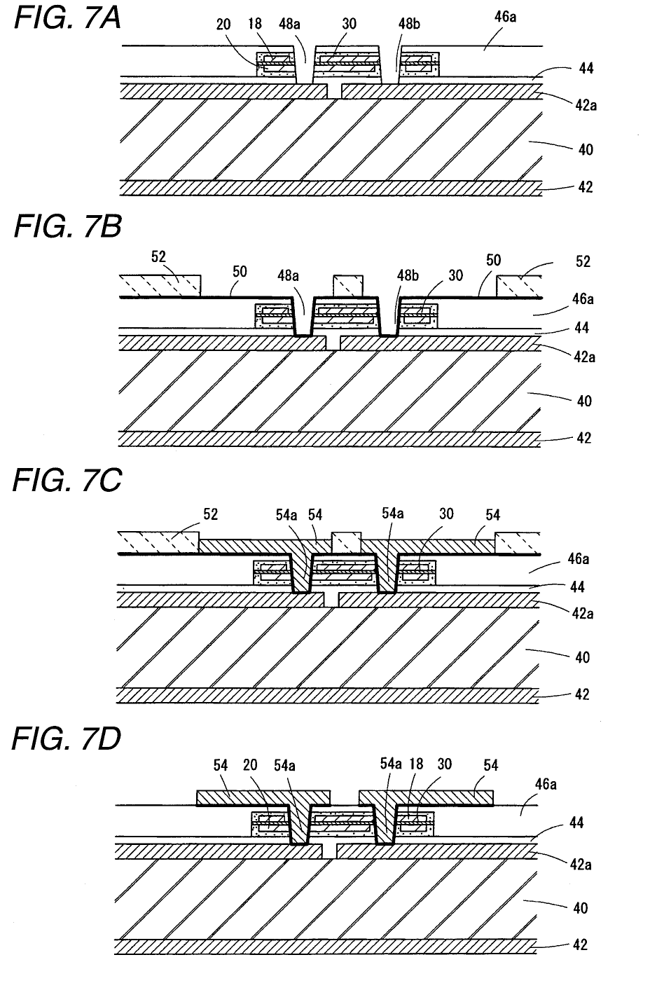

FIGS. 7A to 7D show a process for electrically connecting the upper electrode 18 and the lower electrode 20 in the capacitor component 30 buried and disposed in the insulating layers 44 and 46a to the wiring pattern between the layers.

FIG. 7A shows a step of forming a via hole corresponding to a position in which the capacitor component 30 is provided. Via holes 48a and 48b are formed in alignment with the opening holes 18a, 18b, 20a and 20b provided on the capacitor component 30 from above the insulating layer 46a by using a CO₂ laser or a UV-YAG laser. The insulating layers 46a and 44 can be easily perforated by a laser processing and the dielectric layer 14 can also be perforated readily by the laser processing.

As described above, the opening holes 18a and 20a having the small diameters and the opening holes 18b and 20b having the large diameters are formed on the upper electrode 18 and the lower electrode 20 in combination.

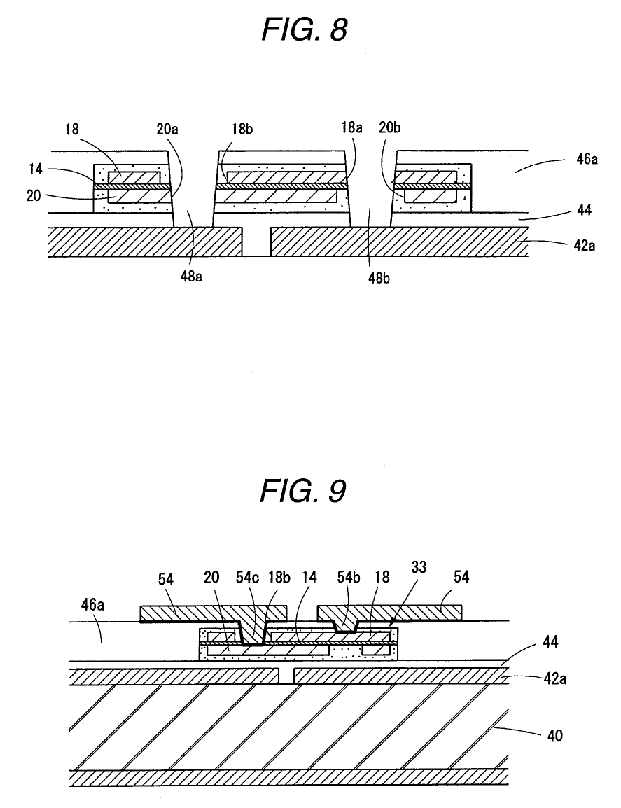

FIG. 8 shows an enlarged state in which the via holes 48a and 48b are formed. In a via hole processing, diameters of the via holes in a portion passing through the capacitor component 30 are set to be larger than the opening holes 18a and 20a having the small diameters and to be smaller than the opening holes 18b and 20b having the large diameters.

In the via hole 48a shown in FIG. 8, the opening hole 18b of the upper electrode 18 has a large diameter and the opening hole 20a of the lower electrode 20 has a small diameter. Accordingly, the via hole 48a is arranged to cross the lower electrode 20 with overlapping and does not interfere with the upper electrode 18. To the contrary, the via hole 48b is arranged to cross the upper electrode 18 with overlapping and does not interfere with the lower electrode 20.

In the via hole processing, thus, the via holes are formed in such a manner that one of them crosses the upper electrode 18 with overlapping and the other crosses the lower electrode 20 with overlapping. Consequently, a wiring is connected to an electrode on a positive side and an electrode on a negative side in a decoupling capacitor separately. As described above, an opening hole can be properly formed on the upper electrode 18 and the lower electrode 20 in the capacitor component. In the case in which the via hole is formed, therefore, it is preferable to properly select the opening hole, thereby forming the via hole in consideration of an arrangement of the wiring pattern in the layer.

FIGS. 7B and 7C show a process for forming a wiring pattern to be electrically connected to the capacitor component 30.

FIG. 7B shows a state in which a plated seed layer 50 is formed by eletroless copper plating and a resist pattern 52 is then formed after the via hole processing. While FIG. 7B illustrates a portion to be connected to the capacitor component 30, the resist pattern 52 is subjected to patterning in accordance with all of wiring patterns of a second layer formed on a surface of the insulating layer 46a.

FIG. 7C shows a state in which a wiring pattern 54 to be a second layer is formed by electrolytic copper plating using the plated seed layer 50 as a plated feeding layer.

FIG. 7D shows a state in which the resist pattern 52 is removed and an exposed portion of the plated seed layer 50 is then removed to form the wiring pattern 54 to be the second layer into an independent pattern.

The wiring pattern 54 to be the second layer is electrically connected, through a via 54a, to the wiring pattern 42a to be a first layer which is a lower layer.

Moreover, the upper electrode 18 and the lower electrode 20 in the capacitor component 30 are electrically connected to one of the wiring patterns 54 and the other wiring pattern 54 through the via 54a, respectively. More specifically, one of the wiring patterns 54 is electrically connected to the upper electrode 18 which is one of electrodes of the capacitor component 30 and the other wiring pattern 54 is electrically connected to the lower electrode 20 which is the other electrode of the capacitor component 30 so that the decoupling capacitor is incorporated in the substrate.

After the capacitor component 30 is provided between the layers, a general buildup process is utilized to provide a wiring pattern as a multilayer, thereby forming a wiring substrate.

Although the capacitor component 30 is mounted on the core substrate 40 in the embodiment, it is possible to mount the capacitor component 30 between optional layers of the multilayer wiring substrate in addition to a portion placed on the core substrate 40 as is apparent from the manufacturing process. For example, by providing the capacitor component 30 on a layer placed under a semiconductor chip mounted on the multilayer wiring substrate, it is also possible to mount the capacitor component 30 closer to the semiconductor chip.

Moreover, it is also possible to optionally select the position in which the capacitor component is to be disposed in the plane of the substrate. Thus, it is also possible to arrange the capacitor component in a plurality of places in the same plane. Furthermore, it is also possible to individually mount the capacitor component on a plurality of layers.

### Semiconductor Package: Second Embodiment

FIG. 9 shows an example of a wiring substrate (a semiconductor package) on which the capacitor component 33 illustrated in FIG. 5A is mounted. In the capacitor component 33, only opening holes 18b and 20b having large diameters are formed on the upper electrode 18 and the lower electrode 20, respectively.

Also in the case in which the capacitor component 33 is used, it is possible to provide the capacitor component 33 in the substrate through the same manufacturing process as that shown in FIGS. 7A to 8. The structure of the wiring substrate is different from that of the wiring substrate according to the first embodiment in respect of a structure of the via 54a for electrically connecting the capacitor component 33 to the wiring pattern 54.

In the first embodiment, the via holes 48a and 48b are formed to penetrate from the wiring pattern 54 to be the upper layer to the wiring pattern 42a to be the lower layer. The reason is that the via 54a is formed in alignment with the opening holes 18a to 20b which are provided in the capacitor component 30.

On the other hand, in the capacitor component 33 shown in FIG. 5A, only the opening holes 18b and 20b having the large diameters are formed and the opening holes 18a and 20a having the small diameters are not formed.

When the via hole is formed in a state in which the capacitor component 33 is buried in the insulating layers 46a and 44, accordingly, the via hole is blocked on the surface of the upper electrode 18 in a portion in which the opening hole 18b is not formed in the upper electrode 18. Moreover, the via hole is blocked on the surface of the lower electrode 20 via the dielectric layer 14 in a portion in which the opening hole 18b is formed in the upper electrode 18.

FIG. 9 shows a state in which the wiring pattern 54 and the upper electrode 18 are electrically connected to each other through a via 54b in a portion in which the opening hole 18b is not formed in the capacitor component 33, and furthermore, shows a state in which the lower electrode 20 and the wiring pattern 54 are electrically connected to each other through a via 54c in a portion in which the opening hole 18b is formed in the capacitor component 33.

More specifically, in the embodiment, there is obtained a structure in which the upper electrode 18 and the lower electrode 20 in the capacitor component 33 are connected to each other through the wiring pattern 54 formed on a second layer. Also in this case, there is obtained a structure in which one of the wiring patterns 54 is electrically connected to the upper electrode 18 to be an electrode of the capacitor component 33 and the other wiring pattern 54 is electrically connected to the lower electrode 20 to be the electrode of the capacitor component 33, and a decoupling capacitor is thus provided in a substrate.

In the case in which the capacitor component is mounted on the substrate, thus, it is also possible to mount the capacitor component to be electrically connected to one of the wiring layers disposed with the capacitor component interposed therebetween and to mount the capacitor component to be electrically connected to both of the wiring layers as in the embodiment described above.

Although the capacitor component 33 is mounted with the upper electrode 18 provided on an upper side in FIG. 9, it is also possible to mount the capacitor component 33 by inverting a vertical direction thereof to provide the lower electrode 20 on the upper side.

In the case in which the wiring pattern and the upper electrode 18 or the lower electrode 20 are electrically connected to each other in order to stop an inner bottom face of the via hole in a position of the upper electrode 18 or the lower electrode 20 as in the embodiment, it is sufficient to form at least one opening hole having a larger diameter than the via hole on either the upper electrode 18 or the lower electrode 20.

### Semiconductor Package: Third Embodiment

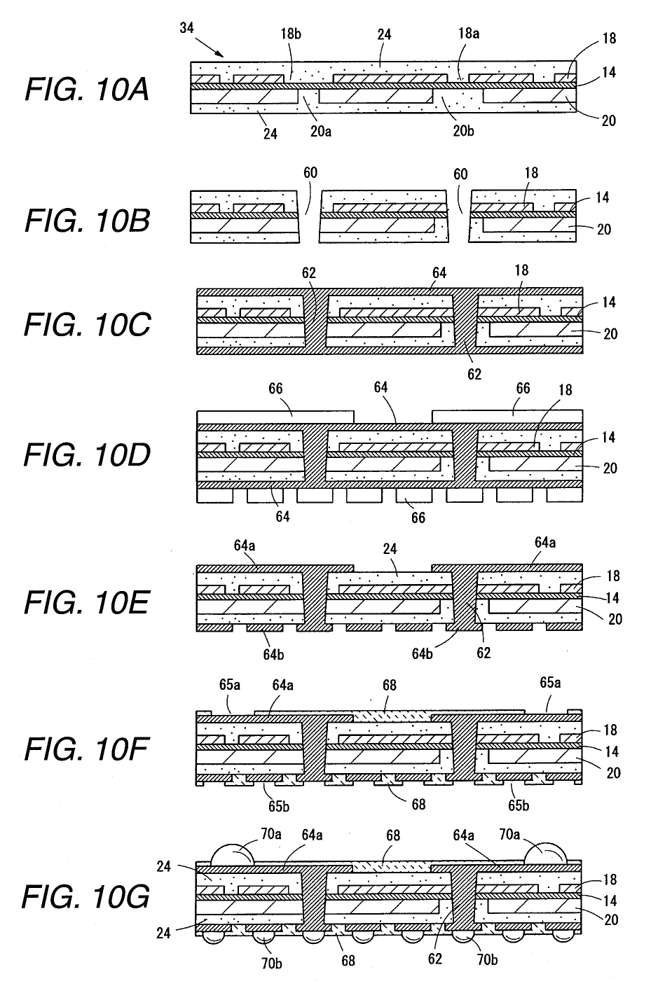

FIGS. 10A to 10G shows an example in which a wiring substrate (a semiconductor package) is formed by setting, as a substrate core, a capacitor sheet body 34 having a structure in which a dielectric layer 14 is interposed between an upper electrode 18 and a lower electrode 20 and an external surface is covered with a covering portion 24 formed by a resin. In the capacitor component 30, the both sides are covered with the covering portion formed by the resin 24a. By applying a predetermined strength to the covering portion 24, therefore, it is possible to use the capacitor component 30 as a core substrate. In the embodiment, the capacitor sheet body 34 is used to form the wiring substrate.

FIG. 10A shows the capacitor sheet body 34 including the dielectric layer 14, the upper electrode 18 and the lower electrode 20 and having the external surface covered with the covering portion 24. The capacitor sheet body 34 is obtained in a previous stage to the formation of the capacitor component 30 through cutting into an individual piece.

A structure in which opening holes 18a and 18b are formed on the upper electrode 18 and opening holes 20a and 20b are formed on the lower electrode 20 is the same as the structure of the capacitor component 30.

FIG. 10B shows a state in which a through hole 60 penetrating the capacitor sheet body 34 in a vertical direction is formed thereon. The through hole 60 can be formed by a laser processing or drilling. The through hole 60 is formed by controlling a forming position and a diameter in such a manner that it crosses the upper electrode 18 with overlapping at one of sides and crosses the lower electrode 20 with overlapping at the other side.

FIG. 10C shows a state in which both sides of the sheet body 34 is subjected to electrolytic copper plating, the through hole 60 is filled with a plating copper 62 and a copper layer 64 is formed on the both sides of the sheet body 34 at the same time.

Subsequently, a resist pattern 66 is formed on the both sides of the sheet body 34 (FIG. 10D). The resist pattern 66 serves to pattern the copper layer 64 bonded to the both sides of the sheet body 34, thereby forming a wiring pattern.

FIG. 10E shows a state in which the copper layer 64 is patterned by using the resist pattern 66 as a mask and the resist pattern 66 is then removed. There is shown a state in which wiring patterns 64a and 64b are formed on the both sides of the sheet body 34.

FIG. 10F shows a state in which a photosensitive solder resist is applied to the both sides of the sheet body 34 and a solder resist 68 is patterned to expose a portion in which a pad is to be provided in order to form the pad to which an external connecting terminal is to be bonded. A pad 65a is formed on the wiring pattern 64a provided on the upper surface of the sheet body 34 and a pad 65b is formed on the lower surface of the sheet body 34.

When the solder resist 68 is patterned, the copper layers are exposed in the pad 65a and 65b portions. Therefore, nickel plating and gold plating are applied as protective plating to the pad 65a and 65b portions in this order.

FIG. 10G shows a state in which solder balls are bonded as external connecting terminals 70a and 70b to the pads 65a and 65b. At a step of bonding the external connecting terminals 70a and 70b, a solder is supplied to the pads 65a and 65b by solder printing and the solder balls are mounted, and a solder reflow is carried out.

In the embodiment, a large sheet body is used. At the solder reflow step, the sheet body is cut into an individual piece or a strap to bond the external connecting terminals 70a and 70b.

Thus, it is possible to obtain a wiring substrate having a structure in which a decoupling capacitor is provided in the core substrate itself and the upper electrode 18 and the lower electrode 20 in the capacitor are electrically connected to the wiring pattern formed on the surface of the substrate.

FIG. 10G shows a section of the capacitor portion provided in the wiring substrate. The manufacturing process is basically the same as a process for manufacturing a double-sided wiring substrate using a core substrate. More specifically, in the manufacturing process, a predetermined wiring pattern is formed on both sides of the wiring substrate in addition to the wiring pattern to be connected to the capacitor so that there is obtained a wiring substrate (a semiconductor package) having the same structure as a double-sided wiring substrate to be generally used.

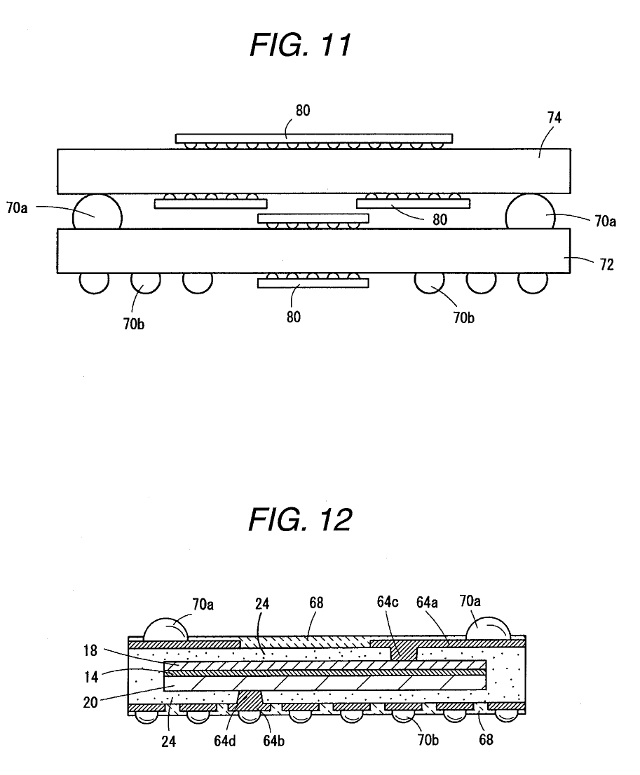

FIG. 11 shows an example in which a semiconductor element 80 is mounted on a wiring substrate 72 obtained by the manufacturing method to constitute a semiconductor package (POP: Package on Package) formed by stacking wiring substrates in two steps. The decoupling capacitor is provided in the wiring substrate 72. A substrate including the decoupling capacitor may be used as a wiring substrate 74 in an upper step. The external connecting terminal 70a is formed to have a large diameter so that a space for mounting the semiconductor element 80 thereon is maintained between the wiring substrates 72 and 74.

As in the semiconductor device according to the embodiment, it is possible to stabilize a source potential by providing the decoupling capacitor in the substrate. A thickness of the wiring substrate including the decoupling capacitor can be reduced also in case of a stack type, for example, a semiconductor package of a POP type. Moreover, it is a matter of course that a semiconductor package using a single wiring substrate can be constituted in addition to the POP type.

FIG. 12 shows another example in which the capacitor structure having the dielectric layer 14 interposed between the upper electrode 18 and the lower electrode 20 and protecting the external surface with the covering portion 24 formed by the resin 24a is utilized for the core substrate. In the example, an opening hole is not provided on the upper electrode 18 and the lower electrode 20, and the wiring patterns 64a and 64b formed on both sides of the substrate are electrically connected to the upper electrode 18 and the lower electrode 20 through vias 64c and 64d, respectively. The electrical connection between the wiring patterns 64a and 64b formed on the both sides of the substrate is carried out by a through hole provided on the substrate in the same manner as in a related-art double-sided wiring substrate. In case of a semiconductor package having the structure, the upper and lower electrodes 18 and 20 to be used for the capacitor structure provided in the substrate can be set to have a single film structure in which the opening hole is not provided.

As a method of incorporating the capacitor structure into the core substrate, it is also possible to employ a structure in which the wiring pattern and the upper and lower electrodes 18 and 20 are electrically connected to each other from one of the surface sides of the substrate shown in FIG. 9.

The wiring substrate (the semiconductor package) including the capacitor component or the capacitor structure according to the invention has the structure in which the dielectric layer 14 is interposed between the upper electrode 18 and the lower electrode 20. Therefore, it is possible to maintain a larger electric capacitance by increasing the size of the dielectric layer 14, that is, the sizes of the upper electrode 18 and the lower electrode 20. By employing the structure in which the dielectric layer 14, the upper electrode 16 and the lower electrode 20 are stacked, moreover, it is possible to reduce a thickness and a size and to easily carry out an incorporation into a buildup layer, thereby forming a wiring substrate of an internal capacitor type. Furthermore, the upper electrode 18 and the lower electrode 20 can be formed into an optional pattern. Therefore, there is an advantage that the patterns of the electrode and the opening hole can be properly designed depending on a product incorporating the capacitor component.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A capacitor component comprising:
an upper electrode and a lower electrode which are formed like flat plates;
a dielectric layer interposed between the upper electrode and the lower electrode; and
a covering portion which covers an external surface of at least one of the upper electrode and the lower electrode and is formed by an insulating resin.

2. The capacitor component according to claim 1, wherein at least one of the upper electrode and the lower electrode includes at least one opening hole having a larger diameter than a via formed in a connection to a wiring pattern when the capacitor component is to be included in a substrate.

3. The capacitor component according to claim 2, wherein both the upper electrode and the lower electrode include opening holes having larger diameters than the via and opening holes having smaller diameters than the via, respectively, and
the opening holes having the smaller diameters which are formed on the upper electrode and the lower electrode are provided to be positioned in a plane region of the opening holes having the larger diameters which are formed on the lower electrode and the upper electrode, respectively.

4. The capacitor component according to claim 3, wherein the opening hole is formed to take a planar shape of a circle and the opening holes having the smaller and larger diameters are disposed concentrically.

5. A method of manufacturing a capacitor component using a capacitor sheet in which a dielectric layer is provided on a surface of a support layer formed of a metal and a metal layer is provided on the dielectric layer, comprising the steps of:
etching the metal layer and the support layer into a predetermined pattern and forming them as an upper electrode and a lower electrode, respectively;
covering, with an insulating resin, at least one of surfaces of the capacitor sheet on which the upper electrode and the lower electrode are formed; and
cutting the capacitor sheet having a covering portion formed by the insulating resin into the capacitor component to be an individual piece.

6. A semiconductor package comprising:
a capacitor component buried in an insulating layer, the capacitor component including an upper electrode and a lower electrode which are formed like flat plates, a dielectric layer interposed between the upper electrode and the lower electrode, and a covering portion which covers an external surface of at least one of the upper electrode and the lower electrode and is formed by an insulating resin;
a wiring pattern formed on the insulating layer; and
vias through which the upper and lower electrodes and a wiring pattern are electrically connected to each other.

7. The semiconductor package according to claim 6, wherein the capacitor component includes opening holes having larger diameters than the via and opening holes having smaller diameters than the via on both the upper electrode and the lower electrode, and the opening holes having the smaller diameters which are formed on the upper electrode and the lower electrode are provided to be positioned in a plane region of the opening holes having the larger diameters which are formed on the lower electrode and the upper electrode, respectively,
the vias are provided to penetrate the insulating layer and the capacitor component in a vertical direction in alignment with the opening holes having the smaller diameters which are formed on the upper electrode and the lower electrode, respectively, and
one of the vias is electrically connected to the upper electrode and the other via is electrically connected to the lower electrode.

8. The semiconductor package according to claim 6, wherein the capacitor component includes at least one opening hole having a larger diameter than the via on at least one of the upper electrode and the lower electrode, and
one of the vias is connected to one of the upper electrode and the lower electrode and the other via is connected to the other in alignment with a position of the opening hole.

9. A semiconductor package comprising:
a core substrate with a capacitor structure, the capacitor structure including an upper electrode and a lower electrode which are formed like flat plates, a dielectric layer interposed between the upper electrode and the lower electrode, and a covering portion which covers external surfaces of the upper electrode and the lower electrode and is formed by an insulating resin;
a wiring pattern formed on a surface of the core substrate; and
vias through which the upper and lower electrodes are electrically connected to each other.

10. The semiconductor package according to claim 9, wherein the capacitor structure includes opening holes having larger diameters than the via and opening holes having smaller diameters than the via on both the upper electrode and the lower electrode, and the opening holes having the smaller diameters which are formed on the upper electrode and the lower electrode are provided to be positioned in a plane region of the opening holes having the larger diameters which are formed on the lower electrode and the upper electrode, respectively, and
the vias are provided to penetrate the core substrate in a vertical direction in alignment with the opening holes having the smaller diameters which are formed on the upper electrode and the lower electrode, respectively, and one of the vias is electrically connected to the upper electrode and the other via is electrically connected to the lower electrode.

11. The semiconductor package according to claim 9, wherein the capacitor structure includes at least one opening hole having a larger diameter than the via on at least one of the upper electrode and the lower electrode, and
one of the vias is connected to one of the upper electrode and the lower electrode and the other via is connected to the other in alignment with a position of the opening hole.
